(19) United States
(12) Patent Application Publication
(10) Pub. No.: US 2020/0087213 A1
(43) Pub. Date: Mar. 19, 2020

(54) METHOD AND DEVICE FOR DENSIFYING MATERIALS OR CONSOLIDATING AN ASSEMBLY OF MATERIALS BY HYDROTHERMAL OR SOLVOTHERMAL SINTERING

(71) Applicants: UNIVERSITE DE BORDEAUX, Bordeaux (FR); NATIONAL DE LA RECHERCHE SCIENTiFIQUE - CNRS, Paris (FR)

(72) Inventors: GRAZIELLA GOGLIO, Taience (FR); Alain LARGETEAU, Cestas (FR); Arnaud NDAYISHIMlYE, Pessac (FR); Mythiti PRAKASAM, Taience (FR)

(73) Assignees: UNIVERSITE DE BORDEAUX, Bordeaux (FR); CENTRE NATIONAL DE LA RECHERCHE SCIENTIFIQDE - CNRS, Paris (FR)

(21) Appl. No.: 16/616,033

(22) PCT Filed: May 23, 2018
(86) PCT No.: PCT/EP2018/063555

§ 371 Date: Nov. 22, 2019

(30) Foreign Application Priority Data
May 23, 2017 (FR) 17 54585

(51) Int. Cl. C04B 35/645; C04B 35/626; C04B 35/14

(52) U.S. Cl. CPC C04B 35/645; C04B 35/14; C04B 35/62675

(57) ABSTRACT

The invention relates to a method and a device for densifying materials or consolidating an assembly of materials wherein a single sintering step is carried out which consists of simultaneously applying, inside a chamber, a uniaxial force and a sintering temperature to the moistened material or the moistened assembly placed in this chamber, said force being applied by at least two pistons which can be moved towards each other inside said chamber, each piston having a housing for recovering the fluid discharged during sintering, the assembly consisting of said chamber and said pistons, and being sealed so that the sintering step is carried out entirely in a liquid medium or in a supercritical fluid medium.

### BACKGROUND OF THE INVENTION

### Field of the invention

The present invention relates to a method for densifying materials or consolidating an assembly of materials comprising a sintering step entirely carried out in a liquid fluid medium or in a supercritical fluid medium.

It also relates to a low-temperature sintering device for the implementation of this method.

It finds applications both in the field of powder metallurgy and in the field of ceramurgy.

### Technological Background

The methods for manufacturing parts by densification with sintering of metallic or non-metallic powders are growing in many technical fields such as in the medical field (dental prostheses, artificial joints, etc.), in the transport field (catalytic converters, bearings, etc.), in the energy field (energy conversion systems of photovoltaic, wind turbine, etc. type), in the electronics field (systems for embedded electronics, heat sinks, etc.), etc.

It is known that the sintering step plays a key role in obtaining dense materials.

To date, in the case of ceramic materials in particular, it is necessary to bring the powders to sintering temperatures above 1000° C. to achieve at least 95% of the theoretical densities.

The reduction in the free surface energy, which is a driving force in sintering, may be favored either by application of a pressure, or by favoring the processes for diffusion of the material via a thermal effect (two-step sintering (TSS), microwave sintering (MWS), spark plasma sintering, flash sintering (FS), hot pressure sintering (HPS), etc.).

Although it is acknowledged that the application of a pressure is beneficial to the densification, the high temperatures required by these methods create several technological barriers, among which mention may particular be made of:
the sintering of materials which are metastable or which decompose at low temperature since these materials are very difficult to sinter with such methods;
the co-sintering of multiple materials is hindered by the differences in thermal stability, in sintering start rates and temperatures, the chemical and/or physical compatibilities between the individual constituents;
the incompatibility of the temperature conditions used with regard to energy saving and/or low production cost criteria.

In order to lower these sintering temperatures, the use of nanosized powders (the grain size typically being between 10 and 100 nm.) has emerged as a key solution owing to the high surface area/volume ratio of the nanoparticles, which constitutes a powerful driving force for promoting the diffusion processes, in particular at high temperatures.

Sintering temperatures of the order of 800° C. have thus been reported for BaTiO₃ powders.

Another advantage of nanocrystalline ceramics is that it is possible to obtain such ceramics having a higher hardness, which gives them better performance levels than conventional ceramics. These characteristics result in high mechanical performance levels.

However, the reduction in the sintering temperatures associated with the use of these nanosized powders has its limits and high temperatures are still required to densify these powders.

Furthermore, competition between the effects of densification and of granular growth may lead to the formation of heterogeneous microstructures with very coarse grains, which is ultimately detrimental to the densification.

A recent method referred to as a “Cold Sintering Process” consists in subjecting a powder, mixed with an aqueous solvent and placed in a mold, to the application of a uniaxial force by means of two movable pistons and of a temperature. The pistons are not provided with gaskets which in fact makes the system non-leaktight, the water evaporating during the sintering in order to be permanently discharged from the mold. The maximum temperatures and pressures used are respectively below 200° C. and 500 MPa over times ranging from 1 to 180 minutes. This method makes it possible to achieve compactnesses of 95%, often after carrying out additional heat treatments.

### Subject of the Invention

The present invention aims to overcome the drawbacks of the prior art by proposing a method for densifying materials or consolidating an assembly of materials, such as ceramic/ceramic assemblies or ceramic/metal assemblies, which is simple in its design and its method of operation, making it possible to significantly lower the sintering temperature while obtaining parts that achieve at least 95% of the theoretical densities.

The present invention also relates to a sintering device for the implementation of this method.

### BRIEF DESCRIPTION OF THE INVENTION

For this purpose, the invention relates to a method for densifying materials (such as metals and ceramics of oxide, sulfate, carbonate, phosphate, silicate, etc. type or non-oxide type, which are crystalline or amorphous) or for consolidating an assembly of materials (such as ceramic/ceramic, ceramic/metal, metal/metal) comprising a single sintering step consisting of the simultaneous application, within a chamber, of a uniaxial force and of a sintering temperature to said material or to said assembly placed in this chamber, said force being applied by at least two pistons that are movable toward one another inside said chamber, the unit formed of said chamber and of said pistons being leaktight so that said sintering step is entirely carried out in a liquid fluid medium or in a supercritical fluid medium.

According to one embodiment of the invention, at least one piston comprises a housing placed between said at least one sealing element and the end of the piston intended to be in contact with said material to be densified or assembly of materials to be consolidated in order to recover at least some of the fluid discharged during the sintering step.

The present invention thus makes it possible to densify materials or to consolidate assemblies of materials at low temperatures, typically below 500° C. and at pressures between 50 and 350 MPa.

Such a process thus makes it possible to manufacture low-cost parts having a high and uniform compactness.

When the sintering step is carried out in aqueous solution, it is observed that the maintaining of this solution in its liquid state, or even supercritical state, during the sintering makes it possible to greatly increase the solubility of inorganic materials that are sparingly soluble in water under atmospheric pressure. Thus, the densification of these materials is significantly increased, and this being for temperatures much lower than those used to date for densifying these materials.

Advantageously, when water is used to hydrate the material or the assembly of materials, a temperature below 373° C. and a pressure above 22 MPa will typically be applied during the sintering step so as to make the method particularly economical. Furthermore, the use of water as solvent during the sintering step makes this method particularly environmentally friendly and safe in terms of public health.

This aqueous solution may be basic or acidic depending on the material to be densified or the materials to be consolidated.

When the chemical nature of the material to be sintered requires it, the aqueous solvent may be replaced by a non-aqueous solvent.

The present invention allows the simultaneous control of the dissolving, precipitation and departure of water reactions during the sintering step.

According to one embodiment of the method of the invention, the unit formed of said chamber and of said pistons is rendered leaktight by at least one sealing element borne by each piston.

Each gasket is thus arranged to cooperate with a section of said chamber in order to ensure the leaktightness of the unit formed by said chamber and said pistons, whether these pistons are at rest or moving.

The leaktightness of this unit advantageously makes it possible to maintain, throughout the sintering step, the aqueous solution or the solvent in a liquid, or even supercritical, form.

Since the sealing elements are caused to move in excursion zones of the sealing elements, during the displacement of said pistons, these excursion zones are advantageously cooled.

It is thus possible to maintain these sealing elements well below a temperature beyond which they could be deteriorated and no longer perform their function of sealing said chamber.

Preferably, each sealing element will also be placed at a distance from the reaction zone in which said sintering temperature and said uniaxial force are applied.

Advantageously, only one section of said chamber, in which said at least two pistons apply said uniaxial force to said material or said assembly of materials, is heated and an intermediate cooling zone is established between each excursion zone and said section of the chamber, the cooling in each intermediate cooling zone being determined in order to create a zone of intermediate temperatures between said section thus heated and the corresponding excursion zone.

Of course, the sealing elements are then far away from the section thus heated.

By way of example, it may be air cooling carried out by cooling fins.

According to another embodiment of the method of the invention, prior to the sintering step, the moisture content of said material or of said assembly of materials is determined and the latter is optionally adjusted for carrying out said sintering step in a liquid fluid medium or in a supercritical fluid medium.

The outer surface thereof is moistened with an appropriate amount of aqueous solution or nonaqueous solvent. Advantageously, the wetting of the outer surface thereof is carried out homogeneously.

According to yet another embodiment of the method of the invention, prior to the sintering step, a step of compacting said material, for example by cold isostatic compaction, or said assembly of materials is carried out.

Preferably, said material or said assembly is moistened before or after compacting.

It may thus be a hydration in the case of water. Since said material is a powder, it is possible, prior to the hydration thereof, to hydroxylate its surface in order to increase its reactivity with water and make the hydration thereof more homogeneous.

According to yet another embodiment of the method of the invention, said uniaxial force is applied directly using said pistons or by means of force transmission elements.

Advantageously, said pistons and/or force transmission elements have bearing surfaces that cooperate with one another in order to define the shape of the part to be manufactured.

Preferably, a pressure of less than or equal to 350 MPa and a sintering temperature of less than or equal to 500° C. are applied in said chamber during said sintering step.

The use of a sintering temperature below or equal to 500° C. advantageously makes it possible to avoid the phenomena of solid-state diffusion and to prevent granular growth.

The present invention also relates to a low-temperature sintering device for the implementation of the method as described above.

According to the invention, this device comprises:
a chamber intended to receive a material to be densified or an assembly of materials to be consolidated,
heating means for bringing said material or said assembly to a sintering temperature,
at least two pistons that are movable in said chamber in order to apply a uniaxial force to said material or said assembly of materials,
each piston comprising at least one sealing element in order to make the unit formed by said chamber and said pistons leaktight, and a housing placed between said at least one sealing element and the end of said piston that is intended to be in contact with said material to be densified or assembly of materials to be consolidated in order to recover at least some of the fluid discharged during the sintering step.

Advantageously, this housing is in the form of a circular groove located between said at least one sealing element and the base of each piston in contact with said material or said assembly of materials, this groove acting as a reservoir for collecting the fluid discharged during the densification.

According to an aspect of the device of the invention, said heating means consist of a heating belt or heating band.

Preferably, this heating belt comprises individual heating elements in order to ensure a uniform heat distribution.

According to another advantageous embodiment of the invention, the heating means consist of a coil that enables heating via an inductive effect. This coil, in the form of a heating belt, consists of at least one winding, made of copper for example. This form of heating means makes it possible to obtain a rapid heating time. By way of example, it is possible to reach 450° C. in 20 minutes.

According to another aspect of the device of the invention, these sealing elements are sealing gaskets, preferably Teflon gaskets or silicone gaskets.

According to another aspect of the device of the invention, since these sealing elements move in excursion zones of said sealing elements, during the displacement of said pistons, said device comprises first cooling means for cooling each excursion zone.

Preferably, said first cooling means comprise a jacket connected to a circuit for supplying coolant such as water, said coolant being intended to circulate in the housing delimited by said jacket in order to ensure the cooling of the corresponding sealing element in contact: with the inner wall of this jacket.

Advantageously, since said heating means are intended to heat only one section of said chamber, said device comprises second cooling means for cooling the portions of said chamber that are placed between said section and said excursion zones of the sealing elements, said second cooling means being configured so that said portions have temperatures intermediate between those of said excursion zones and of said central section.

Purely by way of illustration, said second cooling means consist of cooling fins protruding from the body of the chamber and ensuring air cooling.

Such a cooling of each sealing element advantageously allows the use of higher temperatures without degradation of these sealing elements.

According to yet another aspect of the device of the invention, it comprises at least one force transmission element, each force transmission element being intended to be inserted between one of said pistons and said material or said assembly of materials.

Preferably, said pistons and/or force transmission elements have bearing surfaces that cooperate with one another in order to define the shape of the part to be manufactured.

Purely by way of illustration, each force transmission element is a flexible part such as a disk made of Inconel.

Preferably, the diameter of each force transmission element is greater than the diameter of the bearing surface of each piston.

### BRIEF DESCRIPTION OF THE DRAWINGS

Other advantages, aims and particular features of the present invention will emerge from the following description, given by way of wholly nonlimiting explanation and with regard to the appended drawings in which:

FIG. 1 is a perspective view of a low-temperature sintering device according to one particular embodiment of the present invention;

FIG. 2 is a view of one of the two pistons of the sintering device from FIG. 1 showing the sealing gasket borne by this piston;

FIG. 3 is a schematic representation, in cross section, of the sintering device from FIG. 1.

### DETAILED DESCRIPTION OF AN EMBODIMENT OF THE INVENTION

Firstly, it is noted that the figures are not to scale.

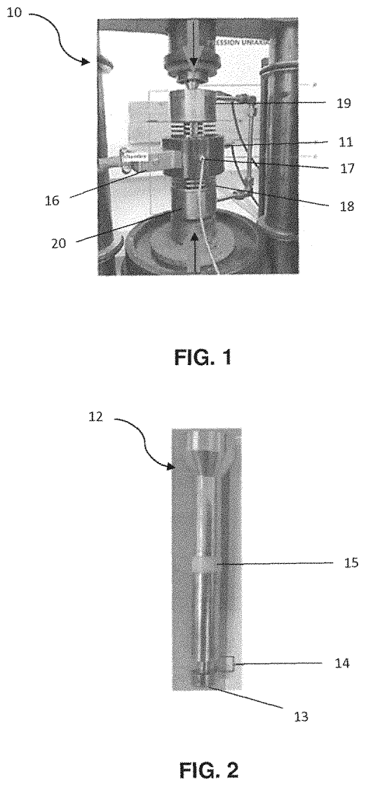

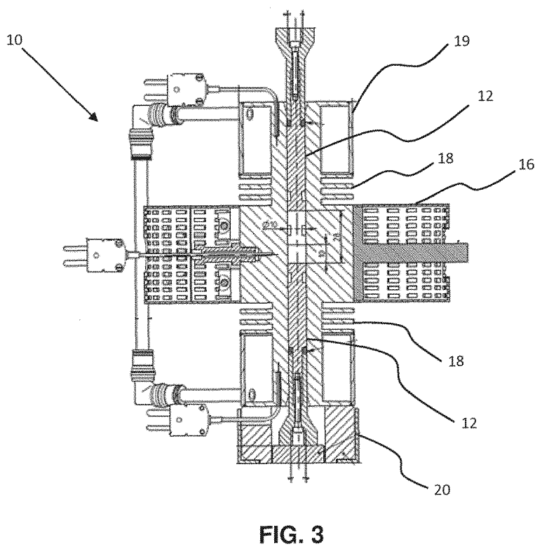

FIGS. 1 to 3 schematically represent a low-temperature sintering device 10 according to one particular embodiment of the present invention.

This device 10 comprises a chamber 11 intended to receive a material to be densified such as a ceramic powder. This powder will have been, prior to the introduction thereof into this chamber 11, compacted in order to reduce its green porosity then moistened uniformly. Of course, it is possible to combine an aqueous or nonaqueous solvent or else a mixture of aqueous and nonaqueous solvents with this powder before compacting of the mixture thus obtained.

This device 10 also comprises two pistons 12 that slide toward one another within this chamber 11 for the application of a uniaxial force on the thus compacted and hydrated powder.

Each piston 12 has a bearing surface 13 placed at its free end intended to come into contact with said powder to be densified, and also a reservoir 14 determined by a circular groove for collecting the overflow of fluid in liquid form discharged during the sintering step and a sealing element 15 placed at a distance from the bearing surface 13 of the piston. This sealing element 15 is here a Teflon gasket.

The gaskets borne by the two pistons 12 sliding in the chamber 11 make it possible to completely close the unit formed by said pistons 12 and said chamber 11, i.e. to seal this unit so that, during the sintering step, the fluid is constantly held inside the chamber 11.

The device 10 also comprises a heating band 16 for heating the section of the chamber 11 in which the two pistons 12 apply a uniaxial force on the thus compacted and moistened powder.

Advantageously, this heating band 16 is configured to apply a sintering temperature below 500° C. to this thus compacted and moistened powder. One or more temperature probes 17, such as thermocouples, make it possible to control this sintering temperature with a view to the regulation thereof by control electronics (not represented).

This device 10 also comprises cooling fins 18 placed either side of the section of the chamber 11 heated by the heating band 16 in order to establish zones of air cooling of the device 10. Such air cooling makes it possible to avoid a substantial lowering of the temperature in the sintering zone.

The sealing elements 15 borne by the pistons 12 move in excursion zones of the chamber 11 during the sliding of the pistons, this device 10 also comprises means 19, 20 for cooling each excursion zone.

These cooling means comprise, here, for each excursion zone, a jacket that defines an inner housing, the inner wall being an integral part of the chamber 11. This housing is connected to a circuit for supplying coolant such as water, which circulates in the housing in order to ensure the cooling of the corresponding sealing gasket. It is also possible to maintain, for example, this gasket at a temperature below 200° C.

The compacted powder is thus subjected, in the presence of a small amount of water or solvent, to a pressure-temperature pairing. The local stress gradients at the intergrain contact zones induce a phenomenon of dissolving at the solid/liquid/solid interfaces and a precipitation which gradually fills the pores of the system.

Advantageously, it is observed that the initial size of the particles is maintained, which makes it possible to preserve nanoscale architectures. Furthermore, the crystalline structure of metastable materials may also be maintained or induced when the sintering step is carried out under suitable temperature and pressure conditions.

A few examples of methods of implementation of the present invention are given below.

### Example 1: Sulfate (Sintering of Ceramics)

The manganese sulfate monohydrate powder used has a micrometer particle size and is naturally hydrated (MnSO₄.H₂O, 2H₂O).

The powder is not mixed with water and has not undergone precompacting.

It is directly introduced into the leaktight chamber in order to be subjected to a hydrothermal sintering at a temperature of 100° C. or 200 ° C. and at a pressure of 350 MPa for 30 minutes.

The material obtained retains a manganese sulfate monohydrate-type structure, and has a compactness of the order of 94% at 100° C. and of 95% at 200° C.

### Example 2: Silica (Sintering of Ceramics)

The (amorphous) silica powder has a particle size of 70 nm. It is mixed with water (33 wt %). The mixture has not undergone precompacting and is introduced into the leaktight chamber of the device of the invention in order to be subjected to a hydrothermal sintering at a temperature of 300° C. and at a pressure of 190 MPa for 30 minutes. The material obtained is an amorphous silica and has a compactness of the order of 75%.

In the case where a silica powder is mixed with an aqueous solvent (20 wt %), precompacted (cold isostatic compaction, 500 MPa, 5 minutes) then introduced into the leaktight chamber of the device of the invention in order to be subjected to a hydrothermal sintering at 300° C. and 350 MPa, for 30 minutes: the material obtained is an amorphous silica and has a compactness of the order of 85% when the solvent is pure water.

### Example 3: α Quartz (Sintering of Ceramics)

The (amorphous) silica powder has a particle size of 50 nm. It is mixed with a 5M aqueous solution of sodium hydroxide (20 wt % of solvent) and precompacted (cold isostatic compaction, 500 MPa, 5 minutes) then introduced into the leaktight chamber of the device of the invention in order to be subjected to a hydrothermal sintering at 300° C. and 350 MPa, for 90 minutes. The material obtained is crystalline, of α-quartz structure and has a compactness of the order of 96%.

### Example 4: Anatase TiO₂ (Sintering of Ceramics)

The powder of TiO₂ of anatase structure consists of submicron clusters (100-200 nm) of 15 nm crystallites. It is then mixed with water (10 wt %). It is then subjected to a step of precompacting (cold isostatic compaction, 200 MPa, 5 minutes).

The compacted mixture obtained is introduced into the leaktight chamber in order to be subjected to a sintering at a temperature of 330° C. and at a pressure of 350 MPa for one hour. The material obtained is of anatase structure, with a retained crystallite size and has a compactness of the order of 62%.

### Example 5: Sintering of Nanostructured Composites

The powder consists of core-shell type nanoparticles with manganite La_{0.67}Sr_{0.33}MnO₃ cores (nanoparticles of 30 nm) coated with a shell that is uniform in terms of thickness and silica SiO₂ composition. The thickness of this layer may be adjusted freely (2 nm at least). The powder is mixed with a 0.2M aqueous solution of sodium hydroxide (20 wt % of solvent) and precompacted (cold isostatic compaction, 500 MPa, 5 minutes) then introduced into the leaktight chamber of the device of the invention in order to be subjected to a hydrothermal sintering at 300° C. and 350 MPa, for 90 minutes. The material obtained is a structured composite of 0-3 type where the manganite nanoparticles are dispersed homogeneously in the amorphous and silica-densified matrix. The relative density lies within the range 77-83% and varies as a function of the initial thickness of the silica layer (10 nm for 77% and 2 or 5 nm for 83%). During the sintering, the size of the manganite nanoparticles does not change and the formation of interphases between the cores and the matrix is not observed, which means that the manganite/silica interfaces are preserved.

1. A method for densifying materials or consolidating an assembly of materials comprising a single sintering step consisting of the simultaneous application, within a chamber, of a uniaxial force and of a sintering temperature to said material or to said assembly placed in this chamber, said force being applied by at least two pistons that are movable toward one another inside said chamber, the unit formed of said chamber and of said pistons being leaktight so that said sintering step is entirely carried out in a liquid fluid medium or in a supercritical fluid medium.

2. The method of claim 1, wherein the unit formed of said chamber and of said pistons is rendered sealed by at least one sealing element borne by each piston.

3. The method of claim 2, wherein since said sealing elements are caused to move in excursion zones of the sealing elements, during the displacement of said pistons, said excursion zones are cooled.

4. The method of claim 3, wherein only one section of said chamber, in which said at least two pistons apply said uniaxial force to said material or said assembly of materials, is heated and an intermediate cooling zone is established between each excursion zone and said section of the chamber, the cooling in each intermediate cooling zone being determined in order to create a zone of intermediate temperatures between said section thus heated and the corresponding excursion zone.

5. The method of claim 1, wherein, prior to the sintering step, the moisture content of said material or of said assembly of materials is determined and is optionally adjusted for carrying out said sintering step in a liquid fluid medium or in a supercritical fluid medium.

6. The method of claim 1, wherein, prior to the sintering step, a step of compacting said material or said assembly of materials is carried out.

7. The method of claim 5, wherein said material or said assembly is moistened before or after compacting.

8. The method of claim 2, wherein at least one piston comprises a housing placed between said at least one sealing element and the end of the piston intended to be in contact with said material to be densified or assembly of materials to be consolidated in order to recover at least some of the fluid discharged during the sintering step.

9. The method of claim 1, wherein a pressure of less than or equal to 350 MPa and a sintering temperature of less than or equal to 500° C. are applied in said chamber during said sintering step.

10. A low-temperature sintering device for the implementation of the method of of claim 1, wherein it comprises:
a chamber intended to receive a material to be densified or an assembly of materials to be consolidated,
heating means for bringing said material or said assembly to a sintering temperature,
at least two pistons that are movable in said chamber in order to apply a uniaxial force to said material or said assembly of materials,
each piston comprising at least one sealing element in order to make the unit formed by said chamber and said pistons leaktight, and a housing placed between said at least one sealing element and the end of said piston that is intended to be in contact with said material to be densified or assembly of materials to be consolidated in order to recover at least some of the fluid discharged during the sintering step.

11. The device of claim 10, wherein said sealing elements are sealing gaskets.

12. The device of claim 10, wherein since said sealing elements move in excursion zones of said sealing elements, during the displacement of said pistons, said device comprises first cooling means for cooling each excursion zone.

13. The device of claim 12, wherein said first cooling means comprise a jacket connected to a coolant supply circuit, said coolant being intended to circulate in the housing delimited by said jacket in order to ensure the cooling of the corresponding sealing element.

14. The device of claim 12, wherein since said heating means are intended to heat only one section of said chamber, said device comprises second cooling means for cooling the portions of said chamber that are placed between said section and said excursion zones of the sealing elements, said second cooling means being configured so that said portions have temperatures intermediate between those of said excursion zones and of said central section.

15. The device of claim 10, wherein it comprises at least one force transmission element, each force transmission element being intended to be inserted between, one of said pistons and said material or assembly of materials
